(19) United States
(12) Patent Application Publication
(10) Pub. No.: US 2019/0204578 A1
(43) Pub. Date: Jul. 4, 2019

(54) MICROSCOPE FOR OBSERVING INDIVIDUAL ILLUMINATED INCLINED PLANES WITH A MICROLENS ARRAY

(71) Applicant: Leica Microsystems CMS GmbH, Wetzlar (DE)

(72) Inventor: Florian Fahrbach, Mannheim (DE)

(21) Appl. No.: 16/328,797

(22) PCT Filed: Sep. 1, 2017
(86) PCT No.: PCT/EP2017/071941

§ 371 Date: Feb. 27, 2019

(30) Foreign Application Priority Data
Sep. 1, 2016 (DE) 10 2016 116 403.8
Feb. 1, 2017 (DE) 10 2017 102 001.2

(51) Int. Cl. G02B 21/36; G02B 21/00; G02B 27/00

(52) U.S. Cl. CPC G02B 21/361; G02B 21/0032; G02B 27/0075; G02B 21/367; G02B 21/0076

(57) ABSTRACT

An optical arrangement for detecting scattered and/or fluorescence light in an inclined plane microscope includes an objective system with an optical axis configured to capture and transmit the scattered and/or fluorescence light from an object side to a tube side. A tube system, situated on the tube side of the objective system, having an optical axis is configured to focus the scattered and/or fluorescence light captured by the objective system in a virtual tube-detector plane. A plurality of optical lenses are arranged between the tube system and the virtual tube-detector plane. The plurality of optical lenses are configured to essentially simultaneously transmit the scattered and/or fluorescence light and focus the scattered and/or fluorescent light into a detector plane spaced apart from the virtual tube-detector plane. Each lens of the plurality of optical lenses has a lower numerical aperture (NA) than the tube system.

### CROSS-REFERENCE TO PRIOR APPLICATIONS

This application is a U.S. National Stage Application under 35 U.S.C. § 371 of International Application No. PCT/EP2017/071941 filed on Sep. 1, 2017, and claims benefit to German Patent Application Nos. DE 10 2016 116 403.8 filed on Sep. 1, 2016 and DE 10 2017 102 001.2 filed on Feb. 1, 2017. The International Application was published in German on Mar. 8, 2018 as WO 2018/041988 A1 under PCT Article 21(2).

### FIELD

The invention relates to an optical arrangement for detecting scattered and/or fluorescence light in a microscope, in particular an inclined plane microscope, comprising an objective system with an optical axis for capturing and transmitting the scattered and/or fluorescence light from an object side to a tube side, and a tube system, situated on the tube side of the objective system, having an optical axis for focusing the scattered and/or fluorescence light captured by the objective system in a virtual tube-detector plane. Furthermore, the invention relates to a microscope, in particular an inclined plane microscope, comprising an optical illumination arrangement for illuminating a sample that is situated in a detection volume defined by the optical illumination arrangement, and an optical arrangement for detecting scattered and/or fluorescence light from the detection volume.

### BACKGROUND

If light field microscopy is combined with light sheet illumination, at least one second objective is typically needed, in addition to the detection objective, for illuminating the sample. This limits the field of application and the usable samples.

In light sheet microscopy, there is also the problem that a second objective must be used for illumination, which illuminates the region of the focal plane of the detection objective.

In the prior art, in particular with inclined plane microscopes (also called “oblique plane microscopes”), a single objective with a large numerical aperture is used to illuminate the sample with a light strip or two-dimensional light sheet tilted relatively to a focal plane of the objective, to thereby form a tilted illumination plane, and to collect the scattered and/or fluorescence light again as perpendicularly as possible to this illumination with the same objective. Since the illumination plane is not perpendicular to the optical axis of the objective, it cannot be focused directly onto a two-dimensional sensor because either unsharp regions of the illumination plane or distortions of the image of the illumination plane can thereby be generated. The illumination plane is inclined relatively to the focal plane of the objective about a tilting axis.

In an inclined plane microscope of the prior art, a so-called erecting unit is usually used, which images the real intermediate image generated by the objective of the illumination plane tilted about the tilting axis sharply and undistortedly on a two-dimensional detector by aligning its focal plane with the tilted real intermediate image of the illumination plane by tilting the erecting unit.

However, the erecting unit only serves to erect the image and to compensate for spherical aberrations. Other optical errors, such as coma, chromatic aberrations and the like, are however not compensated by the additional optical components of the erecting unit; rather, they add up.

### SUMMARY

In an embodiment, the present invention provides an optical arrangement for detecting scattered and/or fluorescence light in an inclined plane microscope. The optical arrangement includes an objective system with an optical axis configured to capture and transmit the scattered and/or fluorescence light from an object side to a tube side. A tube system, situated on the tube side of the objective system, having an optical axis is configured to focus the scattered and/or fluorescence light captured by the objective system in a virtual tube-detector plane. A plurality of optical lenses are arranged between the tube system and the virtual tube-detector plane. The plurality of optical lenses are configured to essentially simultaneously transmit the scattered and/or fluorescence light and focus the scattered and/or fluorescent light into a detector plane spaced apart from the virtual tube-detector plane. Each lens of the plurality of optical lenses has a lower numerical aperture (NA) than the tube system.

### BRIEF DESCRIPTION OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 shows a first embodiment of the optical arrangement according to the invention;

FIG. 2 shows a second embodiment of the optical arrangement according to the invention;

FIG. 3a shows a third embodiment of the optical arrangement according to the invention;

FIG. 3b shows a fourth embodiment of the optical arrangement according to the invention;

FIG. 4 shows a fifth embodiment of the optical arrangement according to the invention; and

FIG. 5 shows a sixth embodiment of the optical arrangement according to the invention.

### DETAILED DESCRIPTION

In an embodiment, the present invention provides an optical arrangement for detecting scattered and/or fluorescence light or a microscope which can do without an erecting unit of the prior art, which furthermore requires less space and in particular fewer optical components and, therefore, is more economical and which also can easily be operated with a plurality of objectives for detection.

The optical arrangement of the type mentioned at the outset achieves these advantages according to an embodiment of the present invention in that a multiplicity of optical lenses is arranged between the tube system and the virtual tube-detector plane, the multiplicity of lenses essentially simultaneously transmitting the scattered and/or fluorescence light and focusing it into a detector plane spaced apart from the virtual tube-detector plane, and each lens of the plurality of lenses having a lower numerical aperture than the tube system.

The numerical aperture of the lenses of the plurality of lenses that is lower in comparison to the tube system results in a depth of field (DOF) that is enlarged compared to the tube system so that a sharply imageable region extending along the optical axis of the optical arrangement is enlarged. The entirety of the regions that can be sharply imaged by the individual lenses can be regarded as a detection volume. The extension of the detection volume along the optical axis can be changed by varying the DOF, whereas the extension perpendicular to the optical axis can be determined by the size and/or the number of lenses or the size of the objective system or tube system.

The optical arrangement according to an embodiment of the invention thus has the advantage that a separate erecting unit does not have to be used to image an illumination plane which extends at an angle within the detection volume—meaning it is not perpendicular to the optical axis of the objective—on a two-dimensional detector.

The optical arrangement according to an embodiment of the invention thus also has the advantage that the region of the illumination plane which is situated along the illumination direction within the depth of field (DOF) of the illumination light beam can be imaged onto the sensor in such a way that it is within the depths of field of the detection system.

This in turn has the advantage that the transmission degree of the detected scattered and/or fluorescence light is not reduced by a plurality of additional lenses of the erecting unit, and the structure of the optical arrangement as a whole can be designed in a simplified, reduced and consequently more cost-effective manner. Furthermore, the solutions according to embodiments of the invention make it possible to exchange the objective or the objective system on the sample. This is difficult when using an erecting unit from the prior art because it is adapted and adjusted to the objective on the sample.

The microscope mentioned at the outset achieves the above-described advantages according to an embodiment of the present invention in that the optical arrangement has a multiplicity of optical lenses for detection, the plurality of lenses transmitting the scattered and/or fluorescence light from the detection volume essentially simultaneously, and each of the plurality of lenses having a lower numerical aperture than the optical arrangement for detection. The optical arrangement for detection can be, for example, a single lens of the tube system of the same aperture as the plurality of lenses. Thus, the microscope according to an embodiment of the present invention also benefits from an increased DOF resulting from the reduced numerical aperture of the plurality of lenses. Thus, the microscope according to an embodiment of the invention can also be manufactured from fewer individual components in a simpler, more space-saving and, consequently, more cost-effective manner. An embodiment of the invention can thus also be understood as a light field microscope with light sheet illumination in which only a single objective is necessary for illumination and detection.

The objective system of the optical arrangement may be understood as an array of at least one optical lens, wherein at least two optical lenses are preferably provided so that chromatic aberrations can be largely compensated by the objective system.

The tube system can be understood as a pure propagation distance of the scattered and/or fluorescence light, wherein however at least one tube lens is preferably provided in order to focus the scattered and/or fluorescence light that is captured by the objective system and can be collimated after the objective system. If no further optical elements are introduced into the beam path of the optical arrangement, focusing of the scattered and/or fluorescence light can be in the so-called virtual tube-detector plane.

However, the multiplicity of optical lenses which can be situated between the tube system and the virtual tube-detector plane changes the convergence of the scattered and/or fluorescence light so that the position of the focus changes by introducing the multiplicity of optical lenses. In this arrangement, the multiplicity of optical lenses images the virtual image generated by the objective.

The multiplicity of optical lenses can also be situated on the other side when viewed from the sample, i.e. along the optical axis behind the virtual tube-detector plane. In this arrangement, the multiplicity of optical lenses images the real image generated by the objective.

The individual lenses of the multiplicity of optical lenses are preferably lenses of positive refractive power, i.e. focusing lenses, so that the optical arrangement focuses the scattered and/or fluorescence light from the object side into a detector plane situated between the multiplicity of optical lenses and the virtual tube-detector plane. The detector plane corresponds to the image-side focal plane of the optical arrangement according to the invention.

The invention, according to an embodiment, thus represents a technically advantageous solution for combining a light field microscope with sample illumination by a light sheet, wherein however only a single objective is necessary to illuminate the sample and to detect the fluorescence emanating from the sample.

The optical arrangement according to the invention and the microscope according to the invention can be further improved by the following respectively advantageous embodiments. Technical features of the following embodiments can be combined or omitted as desired.

In an embodiment of the optical arrangement according to the invention, the plurality of lenses is designed as a microlens array. A microlens array has the advantage that individual lenses of the multiplicity of optical lenses do not have to be positioned separately in the optical arrangement; rather, all lenses of the microlens array can be positioned and/or adjusted together in the optical arrangement. Furthermore, a microlens array has the advantage that the individual microlenses have a numerical aperture (NA) which is generally less than the numerical aperture of separate optical lenses. Since the NA is inversely proportional to the DOF, the microlenses of a microlens array generally have a higher DOF than individual separate lenses.

The microlens array may in particular be of rectangular design and/or adapted to a detector. An image of the illumination plane by the microlens array may preferably have the same two-dimensional dimensions as the two-dimensional detector used.

In another embodiment of the optical arrangement, a beam splitter is provided between the objective system and the tube system. The use of a beam splitter has the advantage that, through it, an illumination beam path can be coupled into the optical arrangement. In particular, the illumination beam path can be coupled into the optical arrangement in such a way that it runs through the objective system. Thus, the objective system can be used to illuminate a sample that is arranged on the object side of the objective system by means of the light of the illumination beam path coupled in via the beam splitter and to transmit the scattered and/or fluorescence light emitted by the sample through the same objective system from the object side to the tube side.

The beam splitter can in particular be a dichroic beam splitter, which essentially fully reflects the coupled light of the illumination and essentially fully transmits the scattered and/or fluorescence light emitted by the sample. In this embodiment of the optical arrangement, the illumination light and the scattered and/or fluorescence light emitted by the sample have a different wavelength. This embodiment can therefore be used for inelastic scattering of the illumination light. In particular, the beam splitter may be designed for an incidence angle of 45° so that it can produce an essentially 90° deflection of the propagation direction of the illumination light.

In a further embodiment of the optical arrangement, a diaphragm is provided between the objective system and the tube system and has a center displaced perpendicularly to the optical axis of the objective system. A diaphragm positioned in this manner has the advantage that the beam path of the scattered and/or fluorescence light predetermined by the diaphragm can be spatially separated from the illumination beam path.

In particular in an inclined plane microscope, the beam path of the detected scattered light and/or fluorescence light intersects the beam path of the illumination light on the object side, i.e. in the sample, at an acute angle. In order to improve the lateral resolution of the microscope, this angle may preferably be selected such that it is between 45° and 90°; particularly preferably, the angle can be a right angle. Scattered light emitted by the illumination plane is emitted in accordance with the scattering properties of the sample in a scattering cone, whereas fluorescence light is emitted isotropically into the half or full space. The diaphragm can mask out scattering light and/or fluorescence light whose direction is antiparallel to the direction of illumination.

When a single objective of large numerical aperture is used, the latter determines an acceptance cone within which light can propagate through the objective. Within this acceptance cone are located a detection cone and an illumination cone, each of which is defined by a numerical aperture of the optical arrangement for detection or for illumination.

The diaphragm according to the invention defines the detection cone so that the regions of the overlap between the detection cone and the illumination cone, measured along a detection axis, can be limited to small overlapping lengths. Small overlapping lengths are to be understood to mean that they are in the order of magnitude of the focused illumination cone. In the case of illumination with a light sheet, such an overlap can be, for example, a single-digit multiple of, e.g., one to four times, the thickness of the light sheet.

However, in SCAPE microscopy, an increased overlap may in particular be desirable in order to achieve a higher collection efficiency of detection. In a SCAPE microscope, a maximum collection efficiency of detection can thus be set, wherein the diaphragm prevents the detection cone and the illumination cone from overlapping in the objective. The diaphragm thus makes it possible to set a compromise between an optimal utilization of the acceptance cone of the objective, a sufficiently high collection efficiency and the achievable lateral resolution.

The diaphragm may preferably be circular and have a fixed diameter. The center is to be regarded as the center point of the circular opening. It is also possible for the diaphragm, in particular the diaphragm aperture, to be variable, i.e. adjustable, so that imaging parameters, such as the transmitted light quantity or the DOF, can be set via the variable diaphragm.

The diaphragm can preferably be situated between the beam splitter and the tube system. This has the advantage that the illumination beam path is not influenced by the diaphragm.

In a further embodiment of the optical arrangement, the optical axis of the tube system is arranged at a parallel offset to the optical axis of the objective system. This embodiment also has the advantage that the beam paths of the illumination light and of the captured scattered and/or fluorescence light intersect on the object side at an acute angle. The offset of this embodiment achieves the same technical effect as the aforementioned diaphragm, the former additionally advantageously linearly imaging the so-called point spread function (PSF for short).

The objective system may define a focal plane (an object-side geometric focal plane) arranged perpendicularly to the optical axis of the objective system. Especially in inclined plane microscopes, an illumination beam path is coupled into the optical arrangement in such a manner that the forming illumination plane is tilted with respect to the focal plane. The illumination plane is tilted relatively to the focal plane about a tilting axis which can be oriented essentially parallelly to the focal plane.

The optical axis of the tube system can be offset in a displacement direction parallel to the optical axis of the objective system, the displacement direction being oriented perpendicularly to the optical axis of the objective system and perpendicularly to the tilting axis of the illumination plane.

The displacement of the optical axis of the tube system can in particular be combined with the aforementioned fixed or variably adjustable diaphragm. Such a displacement has the advantage that the scattered and/or fluorescence light is transmitted axially symmetrically (and not obliquely) through the tube system. As mentioned briefly above, this also has the advantage that the point spread function (PSF) is aligned along the optical axis of the tube system and thus is not tilted with respect to the sensor or not imaged or projected in a tilted manner on the sensor.

In another embodiment of the optical arrangement, a reflective system is arranged between the objective system and the tube system. A reflective system for coupling or deflecting an illumination beam path and/or a beam path of the scattered and/or fluorescence light has the advantage that reflective systems can be designed for broad wavelength ranges. Furthermore, the reflectance of reflective systems is essentially independent of the angle of incidence of the light to be reflected.

The reflective system may comprise mirrors and/or mirror arrangements and/or a prism or a prism arrangement.

The reflective system can further comprise a common reflective element used both for the illumination beam path and for the beam path of the scattered and/or fluorescence light, the illumination beam path and the beam path of the scattered and/or fluorescence light in locally separated regions of the common reflective element impinging thereon.

Further reflective elements can just be situated in the illumination beam path or beam path of the scattered and/or fluorescence light.

This embodiment can be further improved by at least one reflective element of the reflective system being tiltable about at least one tilting axis. This has the advantage, that the tilting of the at least one reflective element can generate a so-called virtual illumination plane, also: virtual light sheet.

A virtual illumination plane is understood to be an essentially two-dimensional illuminated region which is composed of foci of the illumination light generated in temporal succession. A scanning direction of the tiltable reflective element thus determines a first geometric extension of the illumination plane; the extension of the foci determines a further one.

The at least one reflective element of the reflective system can be tiltable about two tilting axes, wherein a first tilting axis permits tilting of the reflective element with a high frequency compared to an acquisition rate of a detector and forms the virtual illumination plane.

Tilting the illumination beam path about the first tilting axis can thus generate the illumination plane. The tilting about a second tilting axis can be done at a lower frequency than the tilting about the first tilting axis so that the generated illumination plane can be moved on the object side and thus scanned through the sample. Preferably, both tilting axes are preferably oriented essentially perpendicularly to one another.

In a further embodiment of the optical arrangement, the multiplicity of optical lenses comprises lenses of different focal length. The use of lenses of different focal length has the advantage that the position of the depth of field of the respective lens on the object side can thereby be varied and in particular adapted to the tilted illumination plane.

The focal length of the respective individual lens of the plurality of lenses, in particular the focal length of a microlens, determines the position of the focus on the object side, i.e. in the sample, along the optical axis of the beam path associated with the respective lens or microlens. The focus is situated centrally within the extension of the sharp region in the object space in the direction of the optical axis.

If the multiplicity of optical lenses comprises lenses of the same focal length, the foci of the respective lens or microlens are situated in a plane oriented perpendicularly to the optical axis of the objective system. As a result of the DOF of the respective lens or microlens, the plurality of lenses thus forms a detection volume which can be imaged sufficiently sharply.

Since the illumination plane, in particular in an inclined plane microscope, is tilted relatively to a plane perpendicular to the optical axis of the objective system, it is advantageous in an embodiment of the optical arrangement according to the invention to adapt the position of the foci along the optical axis of the beam path associated with the respective lens or microlens to the tilted illumination plane.

This can be realized by varying the focal length of the individual lenses or microlenses. A lens or microlens having a smaller focal length has a focus which is formed on the object side farther away from the objective system than the focus of a lens or microlens having a greater focal length.

In another embodiment of the optical arrangement according to the invention, lenses of the multiplicity of optical lenses that are arranged adjacent to each other have different focal lengths. With such an arrangement, the position of the foci of the individual lenses or microlenses can be adapted to the tilted illumination plane.

This is advantageously realized in a further embodiment by the fact that the focal lengths of individual adjacent lenses continuously increase or continuously decrease along a width direction running essentially perpendicularly to the optical axis of the tube system. The width direction is to be understood as the direction that is oriented both perpendicularly to the optical axis of the tube system and perpendicularly to the tilting axis of the illumination plane. The width direction can correspond to the displacement direction.

The term “continuous” is to be understood here in the sense that the focal lengths of the individual lenses along the width direction either increase or decrease, i.e. that the direction of the change in the focal length does not change along or counter to the width direction.

In a further embodiment of the optical arrangement, at least two individual lenses of the multiplicity of optical lenses are arranged at a different distance from the object side. This has the advantage that, for all the individual lenses or microlenses of the plurality of lenses, the magnification ratio can be matched.

The optical arrangement is preferably used in an inclined plane microscope in which, as already described above, an illumination plane is generated to be tilted relatively to the focal plane of the objective system in a sample volume. Different regions of the tilted illumination plane are therefore at different distances from the objective system, i.e. these different regions have a different object distance.

Because of the reduced numerical aperture of the individual lenses or microlenses of the plurality of lenses, each of the individual lenses or microlenses preferably images just one region of the illumination plane, wherein the imaged regions of different individual lenses or microlenses can differ from one another. If the distance of identical individual lenses or microlenses from a detector are set to a common value for all of the individual lenses or microlenses, the magnification ratio of the region respectively imaged by an individual lens or microlens changes with the object distance of the individual regions of the illumination plane. The magnification ratio thus varies in, or counter to, the width direction.

In order to set the magnification ratio for all of the multiplicity of optical lenses essentially at a common value, in this embodiment of the optical arrangement, the individual lenses or microlenses that image regions of the illumination plane having a greater object distance are therefore arranged closer to the object side, i.e. closer to the tube or objective system, than individual lenses or microlenses that image regions of the illumination plane having a smaller object distance.

In another embodiment of the optical arrangement according to the invention, the distance of the individual lenses from the object side changes continuously in a width direction. This has the advantage that due to the continuous change of the image distance, i.e. the distance of the respective image generated by the individual lens from the individual lens or microlens, the magnification ratio is essentially the same for all regions of the tilted illumination plane.

In particular in a further embodiment, the individual lenses can each be arranged at a distance from the object side that is set depending on the focal length of the respective lens, the distance of the respective individual lens from the object side essentially behaving in a manner directly proportional to the focal length of the individual lens. Thus, at the same time, the central focus region of a subsystem comprising a single lens, the tube system and the objective system can be brought to overlap with the region of the tilted illumination plane to be imaged, and the magnification ratio of the region of the tilted illumination plane to be imaged can be set to a predetermined value. This makes it possible to image the scattered and/or fluorescence light from the tilted illumination plane of the sample in an essentially constant magnification ratio with high sharpness that is constant over the image.

The sharpness is to be understood as the distinguishability of details to be imaged and depends inter alia on the numerical aperture of the optical subsystem, comprising a respective lens or microlens of the plurality of lenses, the tube system and the objective system, and the distance of the region of the tilted illumination plane to be imaged from the object-side focal plane of the subsystem.

The microscope according to the invention that was mentioned at the outset can have an illumination beam path that runs, as a result of the optical illumination arrangement, non-collinearly with a detection beam path through the optical arrangement for detection. Furthermore, at least one optical element can additionally or alternatively be arranged simultaneously in the illumination beam path and in the detection beam path.

In a further embodiment of the microscope according to the invention, the plurality of lenses is designed as a microlens array. This has the advantage that individual lenses of the multiplicity of optical lenses can be positioned and/or adjusted together and each of the individual lenses or individual microlenses has a numerical aperture which is generally less than the numerical aperture of separate optical lenses having the same aperture as the microlens array. The reduced numerical aperture results in an increase of the DOF.

The microscope can have a beam splitter or a reflective element tiltable about at least one axis. The beam splitter or the reflective element can be situated both in the illumination beam path and in the detection beam path of the scattered and/or fluorescence light.

In the following, each of the advantageous embodiments of the present invention are explained in more detail with reference to attached drawings. Technical features of the embodiments can be combined with each other and/or omitted as desired, unless the technical effect achieved with the technical feature is of importance. Identical technical features and technical features with the same function are provided with the same reference symbols.

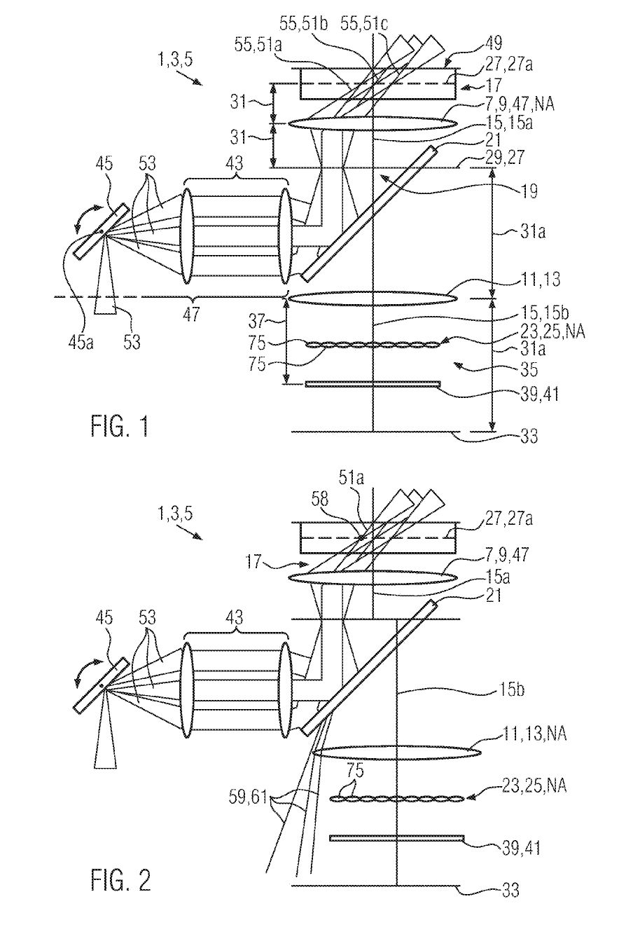

A first embodiment of the optical arrangement 1 according to the invention is shown schematically in FIG. 1. The optical arrangement 1 illustrates beam paths that can occur in a microscope 3, in particular in an inclined plane microscope 5. The microscope 3 or the inclined plane microscope 5 as such are not depicted in the figures but can contain an embodiment of the optical arrangement 1 according to the invention.

The optical arrangement 1 comprises an objective system 7, which comprises only an objective lens 9 in the embodiment shown but may comprise a plurality of lenses in other embodiments. The optical arrangement 1 further comprises a tube system 11, which comprises only one tube lens 13 in the embodiment shown. The tube system 11 may also comprise more than one tube lens 13 in other embodiments.

Both the objective system 7 and the tube system 11 have an optical axis 15, the optical axis of the objective system 15a being coincident with the optical axis of the tube system 15b.

The objective system 7 has an object side 17 and a tube side 19, the tube system 11 being situated on the tube side 19 of the object[ive] system 7.

A beam splitter 21 is arranged between the objective system 7 and the tube system 11, at an angle of essentially 45° to the optical axis 15.

Furthermore, the optical arrangement 1 has a multiplicity of optical lenses 23 which is designed as a microlens array 25.

The objective lens 9, the tube lens 13 and also individual lenses 75 of the microlens array 25 each have a numerical aperture NA, the numerical aperture NA of the individual lenses 75 being generally smaller than the numerical aperture NA of the objective lens 9 or of the tube lens 13.

For the sake of simplicity, thin lenses are assumed below so that focal lengths of a lens are indicated only with reference to the position of the lens and not with reference to the position of the main planes of the lens.

The objective system 7 has an object-side focal plane 27 and an image-side focal plane 29, each of which is at a distance of the focal length 31 of the objective lens 9 from the latter.

The image-side focal plane 29 of the objective lens 9 is at the same time the objective-side focal plane 27 of the tube lens 13 which is situated at a distance of the focal length of the tube lens 31a from the latter.

The image-side focal plane 29 of the tube lens 13 is likewise situated at a distance of the focal length of the tube lens 31a from the latter and forms from it a virtual tube-detector plane 33.

The focal length of the tube lens 31a is shortened on the image side 35 of the tube system 11 by the multiplicity of optical lenses 23, resulting in a nominal focal length 37. A detector plane 39 is arranged at a distance of the nominal focal length 37 from the tube lens 13. A detector 41 is arranged in the detector plane 39 in the embodiment shown in FIG. 1.

Also shown in FIG. 1 is a telecentric 4f optic 43 and a tilt mirror 45. These are part of an illumination arrangement 47 of the microscope 3, the objective system 7, i.e. the objective lens 9, also being part of the illumination arrangement 47.

The illumination of the sample is coupled in via the beam splitter 21, which can be a dichroic beam splitter 21a and focused via the objective system 7 in a focus volume 49 so that an illumination plane 51 or a light sheet is formed.

Three illumination beam paths 53 which result when the tilt mirror 45 is tilted about a tilting axis 45a are shown in FIG. 1.

The illumination beam path 53 in the object-side focal plane 27 of the objective lens 9, i.e. in its rear focal plane 27a, can be tilted by the tilt mirror 45 and the telecentric 4f optics 43, and in this way the illumination plane 51 can be offset in the sample. This is schematically illustrated by a first 51a, second 51b and third illumination plane 51c in FIG. 1.

FIG. 1 shows that the foci 55 are ideally located along the optical axis of the objective system 15a in the center of the focus volume 49. This can be achieved by the illumination beam paths 53 being coupled into the objective system 7 in a prefocused or defocused manner.

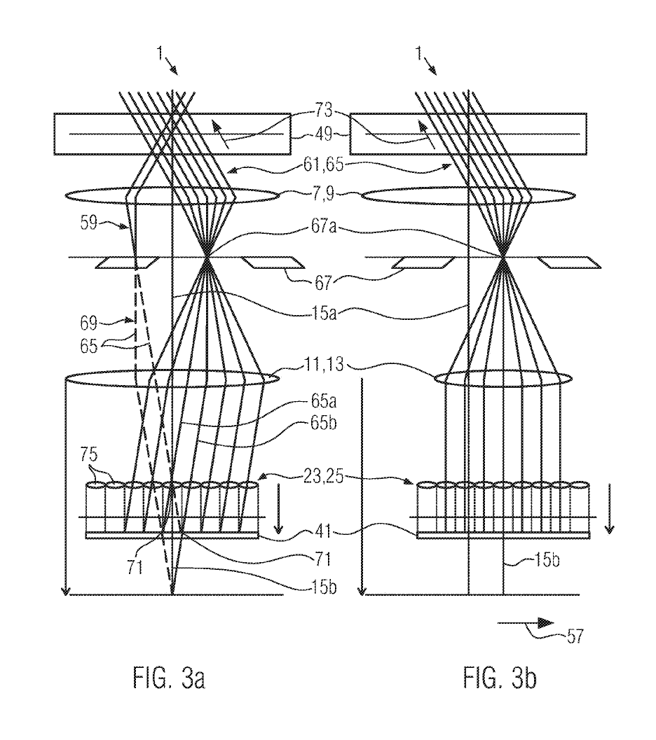

The scattered and/or fluorescence light 61 emitted from the focus volume 49 is still not depicted in FIG. 1. FIGS. 3a and 3b show the beam paths of the scattered and/or fluorescence light 61.

FIG. 2 schematically shows a second embodiment of the optical arrangement 1 according to the invention, wherein, in contrast to the embodiment of FIG. 1, the optical axis of the objective system 15a and the optical axis of the tube system 15b are not coincident in this embodiment.

The optical axis of the tube system 15b is shifted along a width direction 57 with respect to the optical axis of the objective system 15a. The width direction 57 is oriented perpendicularly to the optical axes 15a, 15b and perpendicularly to a tilting axis 58 of the illumination planes 51. The tilting axis 58 projects out of or into the drawing plane and is shown as a point only for the first illumination plane 51a.

For the illumination beam paths 53, the beam path remains identical to the embodiment of FIG. 1 in the embodiment of the optical arrangement 1 shown in FIG. 2. Structural differences only result for the detection of the scattered light and/or fluorescence light (see FIGS. 3a and 3b) since, for example, beam portions 59 of the scattered and/or fluorescence light 61 go past the microlens array 25 as well as the detector 41 and are blocked, for example, on a bracket of the tube lens 13 of the microlens array 25 or of the detector 41.

These beam portions 59, which are viewed from about the same direction from which the sample is illuminated in the focus volume 49, are undesirable in an inclined plane microscope 5, as these portions would degrade the image contrast.

When viewing the sample from about the same direction from which the sample is illuminated, the resolution and/or contrast are not as good as in the case where the observation takes place perpendicularly to the illumination plane. Imaging from a direction which approximately corresponds to the illumination direction should therefore be avoided.

In FIGS. 3a and 3b, the beam paths 63 of the scattered light and/or fluorescence light captured from the focus volume 49 are schematically illustrated using the respective main beams 65.

In the third embodiment of the optical arrangement 1 shown in FIG. 3a, which is essentially based on the optical arrangement of FIG. 1, and in the fourth embodiment of the optical arrangement 1 shown in FIG. 3b, which is essentially based on FIG. 2, a diaphragm 67 is introduced into the respective beam paths 63. The main beams 65 respectively pass through centers 67a of the respective diaphragms 67. FIG. 3a shows a beam portion 59 which corresponds approximately to an observation from the same direction from which the corresponding illumination plane 51 is also illuminated. However, this beam portion 59 is blocked by the diaphragm 67.

For illustration, the theoretical beam path 69 of said beam portion 59 is shown using two main beams 65. These main beams 65 could form when there is no diaphragm 67 introduced into the optical arrangement 1. The theoretical beam paths 69 would impinge the detector 41 through the plurality of lenses 23, i.e. the microlens array 25, and there impinge on the detector 41 with further main beams 65, for example the main beam 65a and the main beam 65b, at a common focus position 71. At these focus positions 71, the sample illuminated by the illumination plane 51 would no longer be laterally resolved.

The diaphragm 67 of the third and fourth embodiment of the optical arrangement according to the invention however prevents such beam portions 59 from reaching the detector 41. The diaphragm 67 thus selects those beam paths 63 of the scattered and/or fluorescence light 61 which are essentially viewed from a detection direction 73 which is oriented essentially perpendicularly to the illumination direction, i.e. the orientation of the illumination plane 51.

The embodiment of the optical arrangement 1 according to the invention shown in FIGS. 3a and 3b further differ in that the tube lens 13 of the first aspect of FIG. 1 is used in the third embodiment of FIG. 3a so that the main beams 65 selected by the diaphragm 67 pass obliquely through the tube lens 13. This may lead to aberrations, such as astigmatism or coma.

Such additional aberrations arising due to beams running obliquely through a lens can be avoided by designing or orienting the tube lens 13 in such a way that the optical axis of the tube system 15b is displaced along the width direction 57 with respect to the optical axis of the objective system 15a. This has the advantage that the main beams 65 selected by the diaphragm 67 run essentially straight through the tube lens 13 and possibly occurring aberrations can thus be reduced or even prevented.

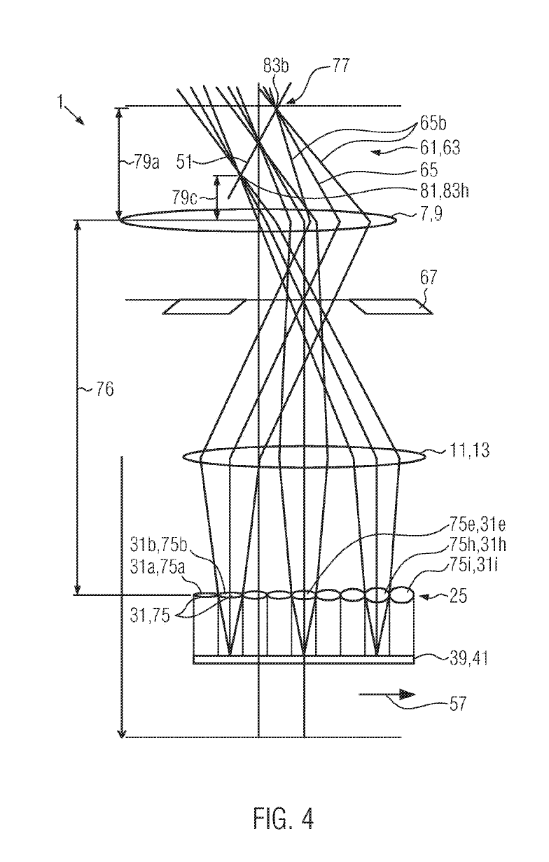

A fifth embodiment of the optical arrangement 1 according to the invention is depicted in FIG. 4. Like the fourth embodiment shown in FIG. 3b, this embodiment comprises the objective system 7 consisting of the objective lens 9, the diaphragm 67, the tube system 11 consisting of the tube lens 13, and a microlens array 25 which images the scattered and/or fluorescence light 61 onto the detector 41 positioned in the detector plane 39. The microlens array 25 is arranged at a distance from the object side 76 from the objective lens 9.

The embodiment shown in FIG. 4 differs from the previously shown embodiments in that the microlens array 25 used has no individual lenses 75 of identical focal length 31; instead, the focal length 31 of different individual lenses 75 are varied over the microlens array 25. This is schematically depicted in FIG. 4 on the basis of the individual lenses 75a to 75h, the individual lens 75a having a focal length 31a which is less than the focal length 31b of the individual lens 75b. For the sake of clarity, not all individual lenses 75b to 75h and their focal lengths 31b to 31h are drawn into FIG. 4.

The focal lengths 31a to 31i are thus continuously reduced as a function of the position of the corresponding individual lens 75a to 75i in the width direction 57.

Also shown in FIG. 4 is that the drawn beam paths 63 of the scattered and/or fluorescence light 61 comprise both the main beam 65a and the marginal rays 65b, these being provided with reference symbols only for a first region 77 of the illumination plane 51.

The first region 77 of the illumination plane 51 has a first distance 79a from the objective lens 9, which is greater than a third distance 79c of a third region 81 of the illumination plane 51.

The focal length 31a to 31i of the individual lenses 75a to 75i is designed in the embodiment of the invention optical arrangement 1 shown in FIG. 4 in such a way that the object-side focal points 83 behave inversely proportionally to the corresponding focal length 31. This is depicted in FIG. 4 on the basis of the individual lenses 75b, 75e and 75h. The individual lens 75b has the focal length 31b which is smaller than the focal length 31d, which in turn is less than the focal length 31a of the individual lens 75a. The individual lens 75b thus has the object-side focal point 83b, which is spaced apart from the objective lens 9 at the first distance 79a. The individual lens 75h has the shorter focal length 31h, which results in the object-side focal point 83h being formed at the third distance 79c away from the objective lens 9.

In this case, the position of the objective-side focal points 83 essentially corresponds to the corresponding regions, for example the first region 77 or the third region 81 of the illumination plane 51 so that the object-side focal points 83 are adapted to the tilted illumination plane 51.

The microlens arrays 25 shown in the figures may comprise individual lenses 75 that can be arranged in a square pattern, but the individual lenses 75 may advantageously also be arranged in a hexagonal grid. The graduation of adjacent individual lenses 75 can be done in discrete steps. In particular, the individual lenses 75 or the individual microlenses can be arranged in different planes, i.e. the individual lenses 75 can be arranged at different distances from the tube lens 13 or from the detector 41 in the optical arrangement 1. As a result, by varying the distance of the individual lenses 75 from the tube lens 13 or from the detector 41, the magnification ratio in the width direction 57 can be set as constant over the complete microlens array 25.

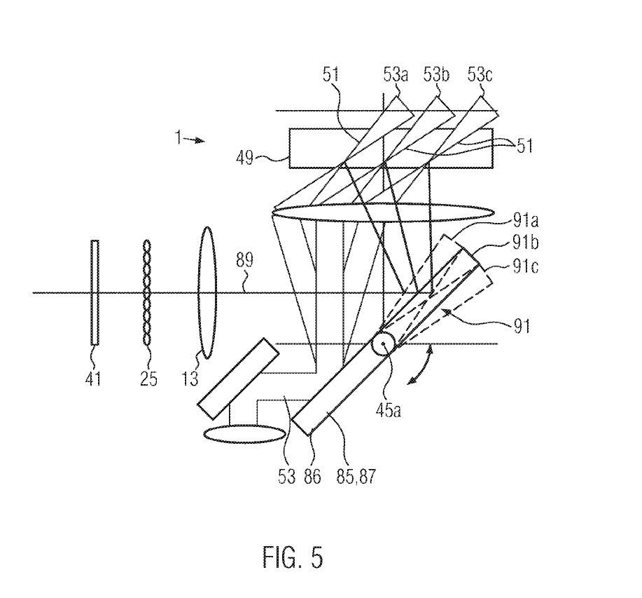

FIG. 5 shows a sixth embodiment of the optical arrangement 1 according to the invention. In this arrangement, a reflective system 85 is provided instead of a beam splitter 21 in the optical arrangement 1. The reflective system 85 of the embodiment shown in FIG. 5 comprises a mirror 87 designed as a reflective element 86 that is tiltable about the tilting axis 45a so that, on the one hand, the illumination beam path 53 can be scanned through the focus volume 49 (this is depicted by three different illumination beam paths 53 in FIG. 5) and, on the other hand, the detection beam path 89 remains unchanged.

FIG. 5 shows that a first illumination beam path 53a is obtained in a first tilt position 91a, a second illumination beam path 53b is obtained in a second tilt position 91b and a third illumination beam path 53c is obtained in a third tilt position 91c of the mirror 87. The first 91a and third tilt position 91c are shown in FIG. 5 only by a dashed line.

Because of the tilting of the mirror 87, a first 89a, a second 89b and a third detection beam path 89c are respectively deflected to one and the same detection beam path 89 so that neither the tube lens 13 nor the microlens array 25 or the detector 41 have to be readjusted as a function of a tilt position 91 of the mirror 87. Thus, by tilting the mirror 87, both the illumination plane 51 and the detection region are offset parallelly.

In general, an important aspect of the optical arrangement 1 according to an embodiment of the invention, and in particular the use of a microlens array 25, is that the individual lenses 75 have a reduced numerical aperture. On the one hand, this substantially reduces the susceptibility of the imaging to spherical aberrations but also reduces the resolution on the other hand. An important aspect of a suitable image processing is therefore to compute the images of the scattered and/or fluorescence light picked up by individual lenses 75 from a suitable structure. This can be done in particular via a so-called multiview deconvolution, that is to say, a deconvolution using the different viewing directions of the individual partial images.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1: An optical arrangement for detecting scattered and/or fluorescence light in an inclined plane microscope, the optical arrangement comprising:
an objective system with an optical axis configured to capture and transmit the scattered and/or fluorescence light from an object side to a tube side;
a tube system, situated on the tube side of the objective system, having an optical axis configured to focus the scattered and/or fluorescence light captured by the objective system in a virtual tube-detector plane; and
a plurality of optical lenses arranged between the tube system and the virtual tube-detector plane, the plurality of optical lenses being configured to essentially simultaneously transmit the scattered and/or fluorescence light and focus the scattered and/or fluorescent light into a detector plane spaced apart from the virtual tube-detector plane, each lens of the plurality of optical lenses having a lower numerical aperture (NA) than the tube system.

2: The optical arrangement according to claim 1, wherein the plurality of optical lenses is designed as a microlens array.

3: The optical arrangement according to claim 1, further comprising a beam splitter disposed between the objective system and the tube system.

4: The optical arrangement according to claim 1, further comprising a diaphragm disposed between the objective system and the tube system and having a center displaced perpendicularly to the optical axis of the objective system.

5: The optical arrangement according to claim 1, wherein the optical axis of the tube system is arranged at a parallel offset to the optical axis of the objective system.

6: The optical arrangement according to claim 1, further comprising a reflective system arranged between the objective system and the tube system.

7: The optical arrangement according to claim 6, wherein at least one reflective element of the reflective system is tiltable about at least one tilting axis.

8: The optical arrangement according to claim 1, wherein the plurality of optical lenses comprises lenses of different focal length.

9: The optical arrangement according to claim 1, wherein adjacently arranged lenses of the plurality of optical lenses have different focal lengths.

10: The optical arrangement according to claim 9, wherein the focal lengths of individual adjacent lenses continuously increase or continuously decrease along a width direction extending essentially perpendicularly to the optical axis of the tube system.

11: The optical arrangement according to claim 8, wherein at least two individual lenses of the plurality of optical lenses are arranged at a different distance from the object side.

12: The optical arrangement according to claim 11, wherein the distance of the individual lenses from the object side continuously changes in the width direction.

13: The optical arrangement according to claim 11, wherein the distance of each of the individual lenses from the object side is defined as a function of the focal length of the respective lens, the distance of the respective individual lens from the object side behaving essentially directly proportionally to the focal length of the individual lens.

14: An inclined plane microscope, comprising:
an optical illumination arrangement for illuminating a sample which is situated in a detection volume defined by the optical illumination arrangement; and
an optical arrangement configured to detect scattered and/or fluorescence light from the detection volume, the optical arrangement having a plurality of optical lenses, the plurality of lenses being configured to essentially simultaneously transmit the scattered and/or fluorescence light from the detection volume, each of the plurality of lenses having a lower numerical aperture than the optical arrangement for detection.

15: The microscope according to claim 14, wherein the plurality of lenses is designed as a microlens array.
